(19) United States
(12) Patent Application Publication
(10) Pub. No.: US 2009/0008487 A1
(43) Pub. Date: Jan. 8, 2009

(54) Loading system for vertical material size reduction system

(75) Inventors: Daniel P. Smith, Spencer, MA (US); Qingsheng Lin, Holden, MA (US); Joshua Creelman, Worcester, MA (US)

Correspondence Address: EDWARDS ANGELL PALMER & DODGE LLP, P.O. BOX 55874, BOSTON, MA, 02205, US

(73) Assignee: Riley Power, Inc., Worcester, MA (US)

(21) Appl. No.: 11/825,106

(22) Filed: Jul. 3, 2007

(51) Int. Cl. B02C 13/20

(52) U.S. Cl. 241/114

(57) ABSTRACT

The invention provides a loading system for a vertical material size reduction system including a pressure frame configured and adapted to be attached to at least one roller wheel assembly of the vertical material size reduction system. The loading system also includes at least one hydraulic cylinder operably connected to the pressure frame. The hydraulic cylinder is configured and adapted to apply a force to the pressure frame to apply pressure through the at least one roller wheel assembly to a grinding table of the vertical material size reduction system. The invention also provides a kit and a method for retrofitting a vertical material size reduction system accordingly.

### BACKGROUND OF THE INVENTION

1. Field of the Invention

The present invention relates to a loading system for a material processing system. Particularly, the present invention is directed to a loading system for a vertical material size reduction system.

2. Description of Related Art

In coal-fired furnaces, for purposes of improved and more efficient ignition, it is preferred to pulverize the coal to a fine powder before introducing it into the furnace for combustion. Coal pulverization involves systematically comminuting coal to a desired, preferably optimum size, e.g. a fine powder, prior to introduction into a coal-fired furnace. Currently, coal pulverization systems include ball tube type mills, high-speed attrition type pulverizers, and vertical roller type mills.

Ball tube type mills are low speed mills that have their origins in the 1930's and 1940's. The ball tube type mill comprises a plurality of hardened steel balls that are disposed in a large, rotatable barrel. While the barrel rotates, coal is introduced into the barrel ends. Through the rotating action of the barrel, the steel balls fall and cascade onto the coal, pulverizing the coal by the impact. The pulverized coal is then removed and fed into a coal-fired furnace. Ball tube type mills are successfully used in conjunction with highly abrasive coal. Ball tube mills rotate at approximately 20 RPM.

A high speed attrition type pulverizer typically, as in the ATRITA® pulverizer available from Riley Power Inc. of Worcester, Mass. (U.S. Pat. Nos. 7,172,146 and 7,028,931) provides three stages of pulverization. Each stage is powered by a common rotary assembly. Coal enters the first (crushing) section where a plurality of rotating and reciprocating swing hammers crush the coal against a grid. The grid deters passage of coal that has not been crushed sufficiently to a preferred nominal size, e.g. about ¼ inch. Once the coal has been reduced to a nominal size, it passes through a grid section and then is introduced into the second section where coal particles are forced to rub together by a set of impellers on a rotating disk, further reducing the coal size. Next, it enters a section where it is forced between a set of high speed rotating pegs and stationary clips. Then the coal exits through a rejecter assembly (while coarse particles are forced back into the previous section for further size reduction), to the final third section. The third section is an exhauster section which transports the fine, pulverized coal in a fluid stream to the coal-fired furnace.

Vertical roller type mills pulverize coal on a rotating grinding table. A plurality of rollers typically cast in abrasion resistant material apply a shearing force downward onto the carrier table and thus apply a grinding pressure to the coal via pressure derived from a set of springs. On the top of the carrier table is mounted a set of segments cast from a similar abrasion resistant material. The pulverized coal is then removed from the mill using a high velocity stream of air and fed into a coal-fired furnace. Vertical pulverizers' rotating tables typically turn at approximately 25 RPM.

Loading the grinding rollers in most vertical coal pulverizers is currently via a set of heavy-duty springs. A set of springs 28 is held between a set of loading and guide frames 26 and 30, as shown in FIG. 1. Hydraulic cylinders are used as a tool to preload the springs which act upon the roller assemblies. The roller assemblies' positions must then be locked into place and the springs act to transfer the grinding pressure on the grinding rollers to the grinding table.

The main disadvantage with this system is that the spring loading is constant and grinding load cannot be adjusted for lower or higher coal throughput rates. The grinding pressure cannot be reset unless the pulverizer is shut down. Once the pulverizer is shut down, the spring loading can be reset to change the pressure exerted onto the roller wheel assemblies, which must then be locked in place again before the pulverizer can startup. An additional disadvantage with this system is that the pulverizer must be started with the grinding rollers in place on the grinding table, which causes vibration and premature wear of the grinding elements while also shortening the useful life of the electrical motor and gear reducer that drive the pulverizer.

Such conventional methods and systems generally have generally been considered satisfactory for their intended purpose. However, there still remains a continued need in the art for a loading system for vertical material size reduction systems that allows for variable pressure for the grinding rollers, wherein the pressure can be varied as a function of mill throughput. There also remains a need in the art for a loading system that has the ability to raise grinding rollers above the grinding table during mill startup. The present invention provides a solution for these problems.

### SUMMARY OF THE INVENTION

The purpose and advantages of the present invention will be set forth in and become apparent from the description that follows. Additional advantages of the invention will be realized and attained by the methods and systems particularly pointed out in the written description and claims hereof, as well as from the appended drawings.

To achieve these and other advantages and in accordance with the purpose of the invention, as embodied herein, the invention includes a loading system for a vertical material size reduction system. The system includes a pressure frame configured and adapted to be attached to at least one roller wheel assembly of the vertical material size reduction system. The system also includes at least one hydraulic cylinder operably connected to the pressure frame. The hydraulic cylinder is configured and adapted to apply a variable force to the pressure frame to apply pressure through the at least one roller wheel assembly to a grinding table of the vertical material size reduction system.

In accordance with a further aspect of the invention, the at least one hydraulic cylinder includes a first pressure chamber on one side of a hydraulic piston, and a second pressure chamber on an opposite side of the hydraulic piston. The hydraulic cylinder is configured and adapted to control pressure between the at least one roller wheel assembly and the grinding table based on a pressure differential between the first and second pressure chambers.

The at least one hydraulic cylinder can include a pneumatic element configured and adapted to absorb mechanical shock. The system can further include at least one tensioning rod connecting the at least one hydraulic cylinder to the pressure frame. The at least one tensioning rod can be connected to the pressure frame in a manner that prevents relative rotational movement between the pressure frame and the tensioning rod along a lengthwise axis defined by the tensioning rod. The system can further include a plurality of pendulum adjustment connectors mounted to the pressure frame. The plurality of pendulum connectors can be configured and adapted to attach roller wheel assemblies to the pressure frame and to align the roller wheel assemblies with the grinding table. The at least one hydraulic cylinder can be configured and adapted to raise the at least one roller wheel assembly off from a grinding table during startup of the vertical material size reduction system. The at least one hydraulic cylinder can be configured and adapted to control pressure between the at least one roller wheel assembly and a grinding table in response to coal throughput rates for the vertical material size reduction system. Moreover, the at least one hydraulic cylinder can be configured and adapted to lift the at least one roller wheel assembly from the grinding table.

The invention also includes a vertical pulverizer for pulverizing coal. The vertical pulverizer includes a pressure frame, at least one roller wheel assembly attached to the pressure frame, and a rotatable grinding table configured and adapted to rotate and to grind coal between the grinding table and the at least one roller wheel assembly. The vertical pulverizer further includes at least one hydraulic cylinder operably connected to the pressure frame. The hydraulic cylinder is configured and adapted to apply a force to the pressure frame to apply pressure through the at least one roller wheel assembly to the grinding table of the vertical pulverizer.

In accordance with a further aspect of the invention, the at least one hydraulic cylinder includes a first pressure chamber on one side of a hydraulic piston, and a second pressure chamber on an opposite side of the hydraulic piston. The hydraulic cylinder is configured and adapted to control pressure between the at least one roller wheel assembly and the grinding table based on a pressure differential between the first and second pressure chambers.

The at least one hydraulic cylinder can include a pneumatic element configured and adapted to absorb mechanical shock. The vertical pulverizer can further include at least one tensioning rod connecting the at least one hydraulic cylinder to the pressure frame. The at least one tensioning rod can be connected to the pressure frame in a manner that prevents relative rotational movement between the pressure frame and the tensioning rod along a lengthwise axis defined by the tensioning rod. The vertical pulverizer can further include a plurality of pendulum adjustment connectors mounted to the pressure frame. The plurality of pendulum connectors can be configured and adapted to attach roller wheel assemblies to the pressure frame and to align the roller wheel assemblies with the grinding table. The at least one hydraulic cylinder is configured and adapted to raise the at least one roller wheel assembly off from a grinding table during startup of the vertical pulverizer. The at least one hydraulic cylinder can be configured and adapted to control pressure between the at least one roller wheel assembly and a grinding table in response to coal throughput rates for the vertical pulverizer.

The invention further includes a kit for retrofitting a vertical material size reduction system. The kit includes a pressure frame configured and adapted to be attached to at least one roller wheel assembly of the vertical material size reduction system. The kit also includes at least one hydraulic cylinder configured and adapted to be operably connected to the pressure frame. The hydraulic cylinder being further configured and adapted to apply a force to the pressure frame to apply pressure through the at least on roller wheel assembly to a grinding table of the vertical material size reduction system.

In accordance with a further aspect of the invention, the at least one hydraulic cylinder includes a pneumatic element configured and adapted to absorb mechanical shock. The kit can further include at least one tensioning rod. The at least one tensioning rod can be configured and adapted to connect the at least one hydraulic cylinder to the pressure frame.

The invention also includes a method of retrofitting a vertical pulverizer. The method includes replacing a spring assembly from a vertical pulverizer with a pressure frame configured and adapted to be attached to at least one roller wheel assembly of the pulverizer. The method further includes attaching at least one hydraulic cylinder to the pressure frame. The hydraulic cylinder is capable of applying a varying force to the pressure frame to apply pressure through the at least one roller wheel assembly to a grinding table of the vertical pulverizer.

The invention also includes a method of operating a vertical pulverizer. The method includes grinding material between at least one roller wheel assembly and a grinding table of the vertical pulverizer. The method also includes adjusting grinding pressure between the at least one roller wheel assembly and the grinding table during operation of the vertical pulverizer.

In accordance with another aspect of the invention the step of adjusting includes adjusting grinding pressure as a function of throughput of the vertical pulverizer. The step of adjusting can also include varying grinding pressure over time.

It is to be understood that both the foregoing general description and the following detailed description are exemplary and are intended to provide further explanation of the invention claimed.

The accompanying drawings, which are incorporated in and constitute part of this specification, are included to illustrate and provide a further understanding of the method and system of the invention. Together with the description, the drawings serve to explain the principles of the invention.

### BRIEF DESCRIPTION OF THE DRAWINGS

FIG. 1 is a partially cut-away perspective view of a traditional vertical pulverizer, showing a typical location of a spring loading assembly.

FIG. 2 is a partially cut-away elevation view of the traditional vertical pulverizer of FIG. 1, showing a traditional loading frame, loading springs, guide frame, tensioning rods, and hydraulic cylinder.

FIG. 3 is a partially cut-away elevation view of a first representative embodiment of a loading system in accordance with the present invention, showing the pressure frame, tensioning rods, and hydropneumatic cylinder.

FIG. 4 is a perspective view of the loading system of FIG. 3 in accordance with the invention, showing the pressure frame, pendulum adjustment connectors, tensioning rods, and hydropneumatic cylinders separate from the pulverizer.

FIG. 5 is a partially cut-away elevation view of the loading system of FIG. 3 in accordance with the invention, showing the connection between the tensioning rod and the pressure frame, as well as between the pressure frame and the roller wheel assemblies.

FIG. 6 is a schematic view of the hydropneumatic cylinder of the loading system of FIG. 3 in accordance with the invention, showing the pneumatic reservoir and N₂ accumulator.

FIG. 7 is a chart of mill load percentage versus hydraulic oil pressure, comparing grinding pressure to counter pressure for a loading system in accordance with the invention.

### DETAILED DESCRIPTION OF THE PREFERRED EMBODIMENT

Reference will now be made in detail to the present preferred embodiments of the invention, examples of which are illustrated in the accompanying drawings. The method and corresponding steps of the invention will be described in conjunction with the detailed description of the system.

The devices and methods presented herein may be used for controlling grinding pressure in a material size reduction system during operation. The present invention is also well suited for reducing wear to a material size reduction system during startup.

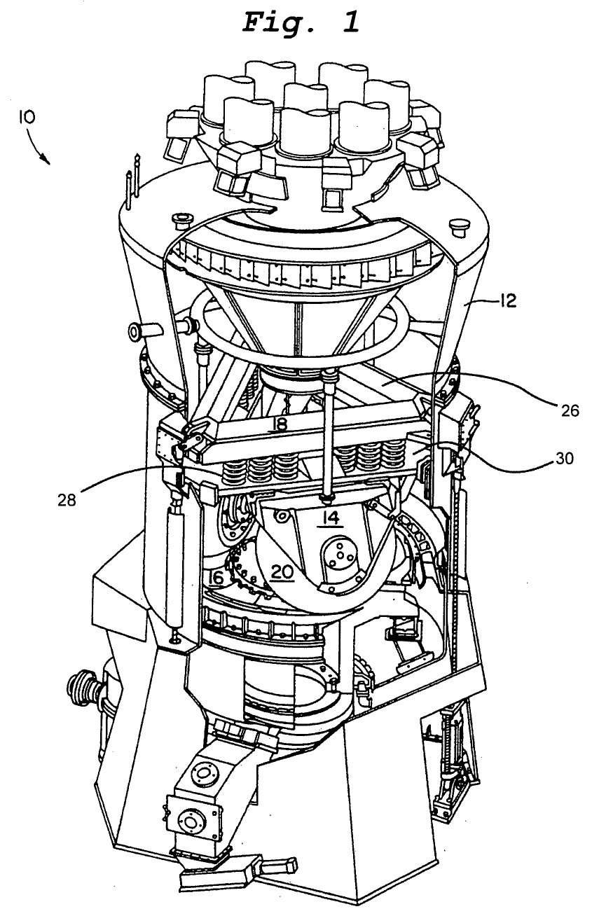

Referring to the Figures generally, wherein like numerals designate the same element throughout the several drawings, FIG. 1 shows a perspective view of a vertical roller-table mill generally designated 10, for grinding incoming material such as coal. The grinding or crushing of coal in the pulverizer 10 is conducted within a pulverizer housing 12. The pulverizer housing 12 contains a plurality of roll wheel assemblies 14, typically three in number, which are pressed against a grinding table 16 by a spring loading system 18. The grinding table 16 rotates about a vertical axis of the pulverizer 10, and each of the roll wheel assemblies 14 has a replaceable outer grinding element or tire 20 mounted for rotation thereon. Each tire 20 rotates around its respective axis of rotation through contact against the grinding table 16. Incoming material is crushed between tires 20 and grinding table 16.

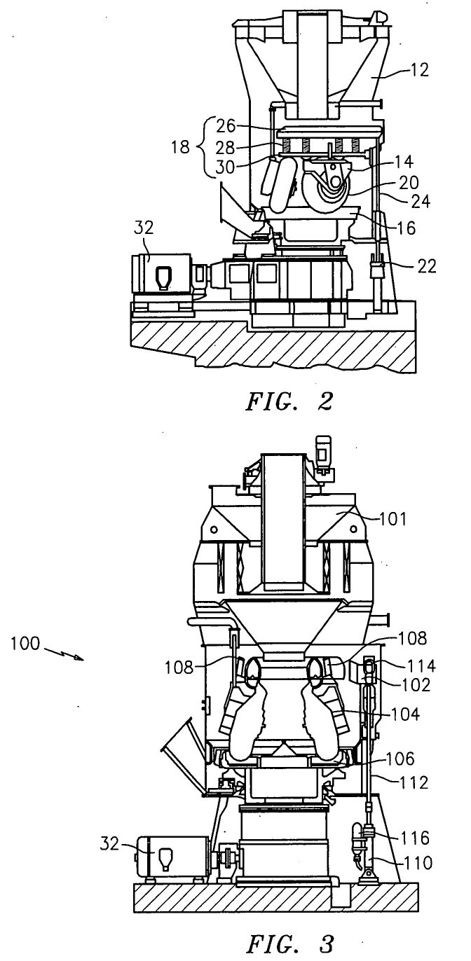

In preparation to operate pulverizer 10, it is necessary to preload spring loading system 18. FIG. 2 shows a traditional mechanism for preloading loading springs 28. Spring loading system 18 includes loading springs 28 sandwiched between loading frame 26 and guiding frame 30. A hydraulic cylinder 22 is used to apply a force to a tensioning rod 24, which is connected to a loading frame 26. When a downward force is applied by hydraulic cylinder 22 to loading frame 26, the force is transferred through loading springs 28 and guide frame 30 into roll wheel assemblies 14. With loading springs 28 preloaded in this manner, pressure is applied between the tire 20 and grinding table 16. Once the desired amount of preloading pressure is attained, loading frame 26 must be locked into place and the tension on hydraulic cylinder 22 and tensioning rod 24 is then released. During operation of pulverizer 10, springs 28 are resilient, allowing for shock absorption. This shock absorbing function protects pulverizer 10 from vibrations from coal or other material being ground between tires 20 and grinding table 16.

The traditional use of spring loading system 18 has various disadvantages. Since loading frame 26 is locked into position during startup procedures, the pressure on roller wheel assembly 14 cannot be adjusted during operation of pulverizer 10. Another disadvantage is that with existing loading system 18, it is necessary to preload springs 28 prior to starting the rotation of grinding table 16. Thus tire 20 is pressed against grinding table 16 during startup, which leads to vibrations that cause extra wear on the various components.

In accordance with the invention, a loading system for a vertical material size reduction system is provided including a pressure frame configured and adapted to be attached to at least one roller wheel assembly of the vertical material size reduction system. At least one hydraulic cylinder is operably connected to the pressure frame. The hydraulic cylinder is configured and adapted to apply force to the pressure frame to apply pressure through the at least one roller wheel assembly to a grinding table of the vertical material size reduction system.

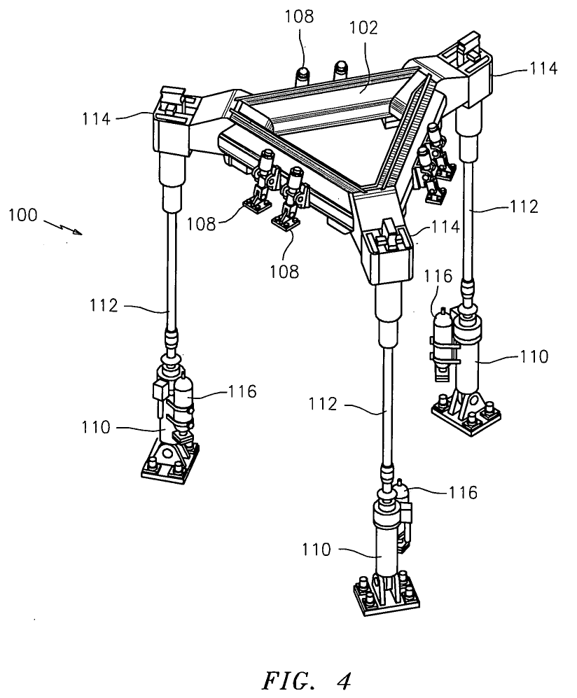

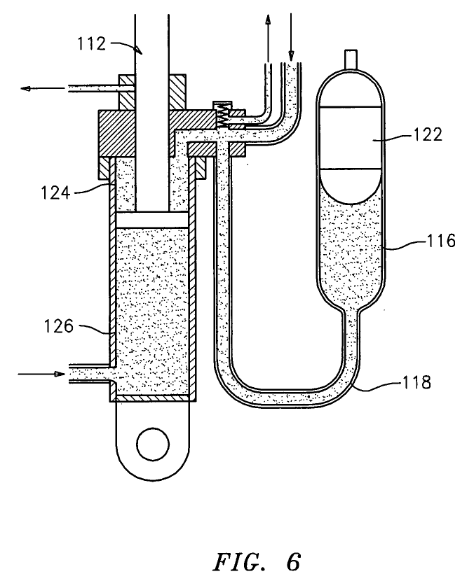

For purposes of explanation and illustration, and not limitation, a partial view of an exemplary embodiment of the loading system in accordance with the invention is shown in FIG. 3 and is designated generally by reference character 100. Other embodiments of a loading system in accordance with the invention, or aspects thereof, are provided in FIGS. 4-6, as will be described.

For purposes of illustration and not limitation, as embodied herein and as depicted in FIG. 3 attached to a pulverizer 101, loading system 100 is provided with a pressure frame 102. Roller wheel assemblies 104 attach to pressure frame 102 and are in contact with grinding table 106. Roller wheel assemblies 104 can be traditional roller wheel assemblies (e.g. 14), or can be of any suitable design for connection to pressure frame 102. Pressure frame 102 includes pendulum joints 108, which connect roller wheel assemblies 104 to Pressure frame 102 and align roller wheel assemblies 104 with grinding table 106. Those skilled in the art will appreciate that pendulum joints 108 are optional, as any suitable means can be used to attach roller wheel assemblies 104 to pressure frame 102 without departing from the spirit and scope of the invention. Pendulum alignment helps insure that rollers 104 seat correctly on the curvature of the segments of table 106. Pressure frame 102 can be made from materials including cast iron, cast steel, welded steel, or any other suitable material.

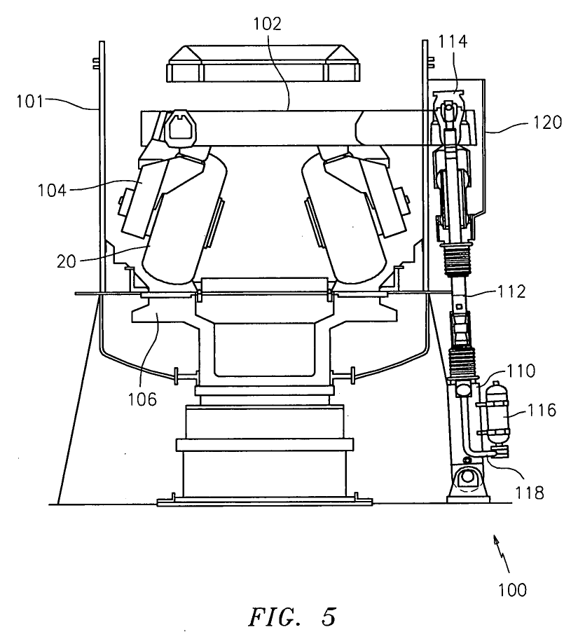

FIG. 4 shows loading system 100 in isolation from the other components of pulverizer 101. Pressure frame 102 is connected to three hydropneumatic cylinders 110 located at the base of loading system 100. Tensioning rods 112 serve to connect between each of the three hydropneumatic cylinders 110 and pressure frame 102. Tangential supports 114 provide a joint between the three tensioning rods 112 and pressure frame 102. Tangential supports 114 are configured to provide stability by constraining relative movement between tensioning rods 112 and pressure frame 102, and particularly to limit rotational movement of rods 112 around their respective lengthwise axes within pressure frame 102. FIG. 5 shows a doghouse 120 covering and protecting tensioning rod 112. Those skilled in the art will readily appreciate that any suitable joints between tensioning rods 112 and pressure frame 102 can be used in conjunction with or in lieu of tangential supports 114 and doghouse 120 without departing from the spirit and scope of the invention. It is possible for tensioning rods 112 to be a piston rod for hydropneumatic cylinders 110, or to be a separate rod connecting to the piston rod.

Referring again to FIG. 4, system 100 is shown having three hydraulic cylinders 110. However, those skilled in the art will readily appreciate that any number of hydraulic cylinders can be used without departing from the spirit and scope of the invention. The same can be said for tensioning rods 112. Moreover, tensioning rods 112 are optional since it is possible, for example, to connect hydraulic cylinders 110 directly to pressure frame 102, without departing from the spirit and scope of the invention.

In accordance with the invention, the hydraulic cylinders of the loading system are configured and adapted to apply a variable force to the pressure frame in response to increased or decreased coal demand, or in response to a change in coal quality. Thus, a variable grinding pressures can be achieved during operation of a vertical material size reduction system.

For purposes of illustration and not limitation, hydropneumatic cylinders 110 can adjustably direct upward or downward forces on pressure frame 102. Thus if pressure frame 102 is unconstrained in the vertical direction, hydropneumatic cylinders 110 can raise or lower the level of pressure frame 102. When roller wheel assemblies 104 attached to pressure frame 102 are in contact with grinding table 106, if hydropneumatic cylinders 110 apply additional force in the downward direction, the pressure between roller wheel assemblies 104 and grinding table 106 is increased. Similarly, if hydropneumatic cylinders 110 have roller wheel assemblies 104 under pressure, hydropneumatic cylinders 110 can be relaxed to relax the pressure on roller wheel assemblies 104. Therefore it is possible to use hydropneumatic cylinders 110 to control the grinding pressure during operation of pulverizer 101.

In order to assure proper grinding and in order to reduce wear, grinding pressure must be determined as a function of pulverizer throughput. Pulverizer throughput includes factors such as variations in coal properties as well as variations in fuel flow demand, if the material being pulverized is coal, for example. Thus if the volume of material to be pulverized is raised or lowered during operation, loading system 100 can be adjusted appropriately without shutting down the pulverizer to adjust the grinding pressure, as required by traditional spring loading system 18.

The ability to vary grinding pressure on the fly provides a significant advantage over traditional spring loading systems (e.g. 18) because grinding pressure can be controlled as a function of pulverizer throughput to reduce wear on grinding components including tires 20 and grinding table 16. Extending the service life of the grinding elements compared to traditional spring loaded systems also shortens outage time required for replacing roller wheel components and table segments of grinding table 106 by approximately 30%. Controlling grinding pressure also helps maintain proper fineness in coal or other materials being pulverized. Adjusting grinding pressure on the fly also enables reduction in electrical power required for reduced load operation. Loading system 100 used in a coal pulverizer, for example, can increase coal throughput at least 20% compared to traditional spring loaded designs.

A further advantage of loading system 101 involves startup of the pulverizer. Hydropneumatic cylinders 110 can raise pressure frame 102 high enough so that roller wheel assemblies 104 clear grinding table 106 completely. Thus, during startup, there is no need for roller wheel assemblies 104 to be pressed against grinding table 106 during the startup of grinding table 106, as there is with traditional spring loading system 18. Raising roller wheel assemblies 104 off from grinding table 106 during startup significantly reduces wear in the grinding elements of pulverizer 101 by reducing vibrations in roller wheel assemblies 104 otherwise experienced between roller wheel assemblies 104 and grinding table 106 as grinding table 106 builds up speed. Raising roller wheel assemblies 104 during startup also extends the life of drive motor 32 (see FIGS. 2-3) and associated gear reducers. Loading system 100 also allows for convenient lifting of roller wheel assemblies 104 in preparation for performing mill maintenance. Automatic mill discharge of coal after mill trips is possible. When a mill trips, roller wheel assemblies 104 are lifted from grinding table 106, which continues to rotate, and the coal remaining on table 106 is flung off by the centrifugal force into a pyrite hopper, which is emptied as required. In previous loading systems, the roller wheel assemblies always rests on the grinding table, even when not preloaded, and had to be lifted off the table by a system of cables.

In further accordance with the invention, and as shown in FIG. 5, hydropneumatic cylinder 110 includes pneumatic reservoir 116. As best seen in FIGS. 2-3, a hydraulic line 118 conducts hydraulic fluid, typically hydraulic oil, between pneumatic reservoir 116 and a first hydraulic piston chamber 124 of hydropneumatic cylinder 110. At one end of pneumatic reservoir is a shock absorbing pressurized gas accumulator 122 containing a gas such as N₂. A second hydraulic piston chamber 126 is situated opposite a piston from the first hydraulic piston chamber 124. In this manner, hydropneumatic cylinders 110 can have hydraulic loading in one direction, and pneumatic loading in the opposite direction, as is known in the art. The pneumatic components 116, 118, and 122 provide shock absorption for loading system 100 and thus obviate the need for springs. This shock absorption is advantageous, however, those skilled the art will appreciate that pneumatic components are optional, as the loading system 100 can use normal hydraulic cylinders with any suitable shock absorbing means without departing from the spirit and scope of the invention.

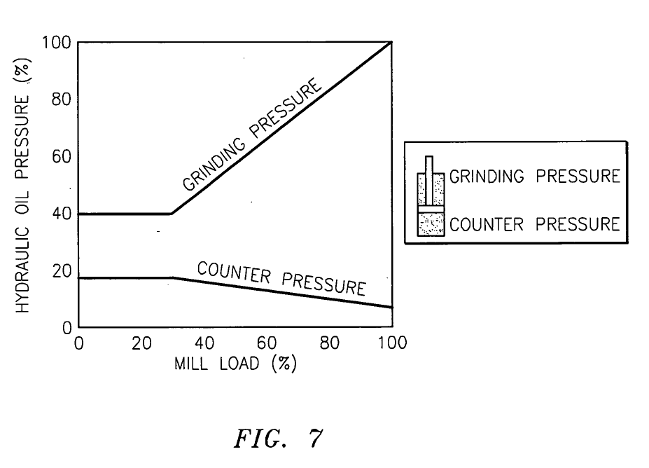

Pressure applied by hydropneumatic cylinders 110 is a function of the differential between pressures within first and second hydraulic piston chambers 124 and 126 of hydropneumatic cylinder 110. One side of a piston, grinding pressure is applied to chamber 124, typically by pressurized hydraulic oil or other suitable liquids as known in the art. On the other side, a counter pressure is similarly applied to chamber 126. The position and/or force acting on tensioning rods 112 is a function of the differential of grinding and counter pressures. FIG. 7 shows grinding and counter pressures as a function of mill load percentage for an exemplary loading system according to the invention. Beyond about 30% mill load, as the mill load increases, the difference between grinding and counter pressures increases, with a positive difference. Hydraulic counter pressure reduces or eliminates mill vibration at reduced mill loads and improves mill turndown.

In further accordance with the invention, a kit is provided for retrofitting a vertical material size reduction system. The kit includes a pressure frame configured and adapted to be attached to at least one roller wheel assembly of the vertical material size reduction system. The kit further includes at least one hydraulic cylinder configured and adapted to be operably connected to the pressure frame. The hydraulic cylinder is further configured and adapted to apply a force to the pressure frame to apply pressure through the at least one roller wheel assembly to a grinding table of the vertical material size reduction system.

For purposes of illustration and not limitation, as embodied herein and as depicted in FIGS. 1-7, it is possible to modify or retrofit an existing vertical pulverizer to incorporate a loading system in accordance with the invention. The kit includes a pressure frame, e.g. pressure frame 102, and at least one hydraulic cylinder, e.g. hydropneumatic cylinders 110 with pneumatic elements 116, 118 as described above. The kit can further include at least one tensioning rod, e.g. tensioning rods 112 described above. It is also contemplated that the kit can include any of the other components of loading system 100 described above. Those skilled in the art will readily appreciate that the kit can include components as separate pieces, or partially assembled, without departing from the spirit and scope of the invention.

In further accordance with the invention, a method is provided for retrofitting a vertical pulverizer. The method includes replacing a spring assembly from a vertical coal pulverizer with a pressure frame configured and adapted to be attached to at least one roller wheel assembly of the vertical pulverizer. The method further includes attaching at least one hydraulic cylinder to the pressure frame. The hydraulic cylinder is configured and adapted to apply a force to the pressure frame to apply pressure through the at least one roller wheel assembly to a grinding table of the vertical pulverizer.

For purposes of illustration and not limitation, as embodied herein and as depicted in FIGS. 1-7, an existing vertical pulverizer can be retrofitted to incorporate a loading system in accordance with the invention as follows. As best seen in FIGS. 2-3, spring loading system 18 must be removed including at least the guide frame 30 and loading springs 28. Loading frame 26 can also be removed and replaced by a pressure frame (e.g. 102), or loading frame 26 can be modified to become a pressure frame. The retrofitting method includes attaching hydropneumatic cylinders (e.g. 110) to the pressure frame. This attachment can be by means of tensioning rods, (e.g. 112). Those skilled in the art will appreciate that various other steps can be included in the retrofitting procedure, without departing from the spirit and scope of the invention. For example, existing roller wheel assemblies can be removed from an existing spring loaded system and attached to a new pressure frame. It is also possible to remove and discard the original roller wheel assemblies and attach new roller wheel assemblies to the pressure frame.

While the methods and systems above have been described in the exemplary context of a vertical pulverizer, and particularly a vertical pulverizer for pulverizing coal, those skilled in the art will readily appreciate that the invention is not limited to use with vertical coal pulverizers. The loading system can be used on any suitable material size reduction system without departing from the spirit and scope of the invention.

The methods and systems of the present invention, as described above and shown in the drawings, provide for a loading system for a vertical material size reduction system with superior properties including reduced wear, reduced down time, and reduced power consumption. It will be apparent to those skilled in the art that various modifications and variations can be made in the device and method of the present invention without departing from the spirit or scope of the invention. Thus, it is intended that the present invention include modifications and variations that are within the scope of the appended claims and their equivalents.

What is claimed is:

1. A loading system for a vertical material size reduction system comprising:
a) a pressure frame configured and adapted to be attached to at least one roller wheel assembly of the vertical material size reduction system; and
b) at least one hydraulic cylinder operably connected to the pressure frame, the hydraulic cylinder being configured and adapted to apply a variable force to the pressure frame to apply pressure through the at least one roller wheel assembly to a grinding table of the vertical material size reduction system.

2. A loading system as recited in claim 1, wherein the at least one hydraulic cylinder includes a first pressure chamber on one side of a hydraulic piston, and a second pressure chamber on an opposite side of the hydraulic piston, and wherein the hydraulic cylinder is configured and adapted to control pressure between the at least one roller wheel assembly and the grinding table based on a pressure differential between the first and second pressure chambers.

3. A loading system as recited in claim 2, wherein the at least one hydraulic cylinder includes a pneumatic element configured and adapted to absorb mechanical shock.

4. A loading system as recited in claim 3, further comprising at least one tensioning rod connecting the at least one hydraulic cylinder to the pressure frame.

5. A loading system as recited in claim 4, wherein the at least one tensioning rod is connected to the pressure frame in a manner that prevents relative rotational movement between the pressure frame and the tensioning rod along a lengthwise axis defined by the tensioning rod.

6. A loading system as recited in claim 5, further comprising a plurality of pendulum adjustment connectors mounted to the pressure frame, the pendulum adjustment connectors being configured and adapted to attach roller wheel assemblies to the pressure frame and to align the roller wheel assemblies with the grinding table.

7. A loading system as recited in claim 1, wherein the at least one hydraulic cylinder is configured and adapted to raise the at least one roller wheel assembly off from a grinding table during startup of the vertical material size reduction system.

8. A loading system as recited in claim 1, wherein the at least one hydraulic cylinder is configured and adapted to control pressure between the at least one roller wheel assembly and the grinding table in response to coal throughput rates for the vertical material size reduction system.

9. A loading system as recited in claim 1, wherein the at least one hydraulic cylinder is configured and adapted to lift the at least one roller wheel assembly from the grinding table.

10. A vertical pulverizer for pulverizing coal comprising:
a) a pressure frame;
b) at least one roller wheel assembly attached to the pressure frame;
c) a rotatable grinding table configured and adapted to rotate and to grind coal between the grinding table and the at least one roller wheel assembly; and
d) at least one hydraulic cylinder operably connected to the pressure frame, the hydraulic cylinder being configured and adapted to apply a force to the pressure frame to apply pressure through the at least one roller wheel assembly to the grinding table of the vertical pulverizer.

11. A vertical pulverizer as recited in claim 10, wherein the at least one hydraulic cylinder includes a first pressure chamber on one side of a hydraulic piston, and a second pressure chamber on an opposite side of the hydraulic piston, and wherein the hydraulic cylinder is configured and adapted to control pressure between the at least one roller wheel assembly and the grinding table based on a pressure differential between the first and second pressure chambers.

12. A vertical pulverizer as recited in claim 11, wherein the at least one hydraulic cylinder includes a pneumatic element configured and adapted to absorb mechanical shock.

13. A vertical pulverizer as recited in claim 12, further comprising at least one tensioning rod connecting the at least one hydraulic cylinder to the pressure frame.

14. A vertical pulverizer as recited in claim 13, wherein the at least one tensioning rod is connected to the pressure frame in a manner that prevents relative rotational movement between the pressure frame and the tensioning rod along a lengthwise axis defined by the tensioning rod.

15. A vertical pulverizer as recited in claim 14, further comprising a plurality of pendulum adjustment connectors mounted to the pressure frame, the pendulum adjustment connectors being configured and adapted to attach roller wheel assemblies to the pressure frame and to align the roller wheel assemblies with the grinding table.

16. A vertical pulverizer as recited in claim 10, wherein the at least one hydraulic cylinder is configured and adapted to raise the at least one roller wheel assembly off from a grinding table during startup of the vertical material size reduction system.

17. A vertical pulverizer as recited in claim 10, wherein the at least one hydraulic cylinder is configured and adapted to control pressure between the at least one roller wheel assembly and a grinding table in response to coal throughput rates for the vertical pulverizer.

18. A kit for retrofitting a vertical material size reduction system, the kit comprising:
a) a pressure frame configured and adapted to be attached to at least one roller wheel assembly of the vertical material size reduction system;
b) at least one hydraulic cylinder configured and adapted to be operably connected to the pressure frame, the hydraulic cylinder being further configured and adapted to apply a force to the pressure frame to apply pressure through the at least one roller wheel assembly to a grinding table of the vertical material size reduction system.

19. A kit for retrofitting a vertical material size reduction system as recited in claim 18, wherein the at least one hydraulic cylinder includes a pneumatic element configured and adapted to absorb mechanical shock.

20. A kit for retrofitting a vertical material size reduction system as recited in claim 19, further comprising at least one tensioning rod, the at least one tensioning rod configured and adapted to connect the at least one hydraulic cylinder to the pressure frame.
